(19) United States
(12) Patent Application Publication
(10) Pub. No.: US 2006/0259556 A1
(43) Pub. Date: Nov. 16, 2006

(54) Tracking electronic mail messages

(76) Inventor: Gero Auhagen, Mountain View, CA (US)

Correspondence Address: FISH & RICHARDSON, P.C., PO BOX 1022, MINNEAPOLIS, MN, 55440-1022, US

(21) Appl. No.: 11/129,976

(22) Filed: May 16, 2005

(51) Int. Cl. G06F 15/16

(52) U.S. Cl. 709/206

(57) ABSTRACT

A method for tracking email messages may include identifying a user email address associated with a user and providing user email content. An email tracking address that is uniquely associated with the identified user email address or with the user email content may be generated. An email message comprising the user email content may be sent to the user at the identified user email address, such that the email message appears to have been sent from the email tracking address. The email message may be sent in response to a user email message. The email message may be sent as part of an unsolicited distribution of email messages to a plurality of recipients. In the email message, a sent-from or a recipient-on-reply field may be set to the email tracking address.

### TECHNICAL FIELD

This disclosure relates to tracking electronic mail (email) messages.

### BACKGROUND

The use of email messages continues to grow in popularity as a means for communication. A company, for example, may use email messages to advertise or to provide solutions to consumers. In both exemplary cases, the company may wish to track the email messages and any subsequent replies or follow-up messages.

For example, the company may provide an email-based service department to which consumers can direct inquiries or questions. A consumer who encounters difficulties with a product of the company, for example, may send an email message to the service department requesting assistance. An agent within the service department may send a first reply message in response to the consumer email message. The agent could be, for example, a human agent. As another example, the agent could be a computer system configured to receive, process, and reply to consumer email messages, such as an email response management system (ERMS). The consumer may send a second reply message in response to the first reply message, for example, to request clarification of the first reply message, to confirm receipt of the first reply message, to request additional assistance, or for another reason.

As another example, a company may use email messages as advertising tools. For example, the company may send advertising email messages to user email addresses associated with the company's customers. The company may further invite responses to the advertising email messages, for example, to assess the effectiveness of an email message advertising campaign.

### SUMMARY

It may be advantageous to track email messages with an email tracking address. The email tracking addresses could be, for example, a “virtual” email address that may or may not be associated with a particular placeholder in an email message client inbox.

In one general aspect, a method for tracking email messages may include identifying a user email address associated with a user and providing user email content. An email tracking address that is uniquely associated with the identified user email address or with the user email content may be generated. An email message may be sent to the identified user email address, such that the email message appears to have been sent from the email tracking address.

The email message may be sent in response to a user email message. The email message may be sent as part of an unsolicited distribution of email messages to a plurality of recipients. For example, the email message content may be associated with a marketing campaign. In the email message, a sent-from or a recipient-on-reply field may be set to the email tracking address. The email tracking address may comprise a unique tracking number. The email tracking address may comprise an alias or generic name. The email tracking address may be associated with one or more related email messages. A reply message to the email message may be received and subsequently processed.

Advantages of the systems and techniques described herein may include any or all of the following. Email messages may be tracked without substantial effort by the recipient. Related email messages may be tracked. Email messages may be tracked without being copied to additional addressees.

These general and specific aspects may be implemented using a system, a method, or a computer program, or any combination of systems, methods and computer programs. The details of one or more implementations are set forth in the accompanying drawings and the description below. Other features, objects, and advantages will be apparent from the description and drawings, and from the claims.

### DESCRIPTION OF DRAWINGS

FIG. 1A is a block diagram of an overall environment in which email messages can be tracked by an email response management system (ERMS), according to some implementations.

FIG. 1B is a block diagram showing additional details of the ERMS that is shown in FIG. 1A, according to some implementations.

FIG. C is a block diagram showing additional details of the response database and content component database that are shown in FIG. 1B.

FIG. 2 is a diagram of a series of email messages that may be tracked by the ERMS shown in FIG. 1A or FIG. 1B, according to some implementations.

FIG. 3 is a flow diagram of a method that the ERMS that is shown in FIG. 1A or FIG. 1B can use to track user email messages, according to some implementations.

FIG. 4 is a block diagram of an exemplary computing device that may be included in user devices, agent devices, the supervisor device, and used for the ERMS that is shown in FIG. 1A.

Like reference symbols in the various drawings indicate like elements.

### DETAILED DESCRIPTION

A company may use the methods, systems and computer program products disclosed herein to track electronic mail (email) messages exchanged with or sent to its customers.

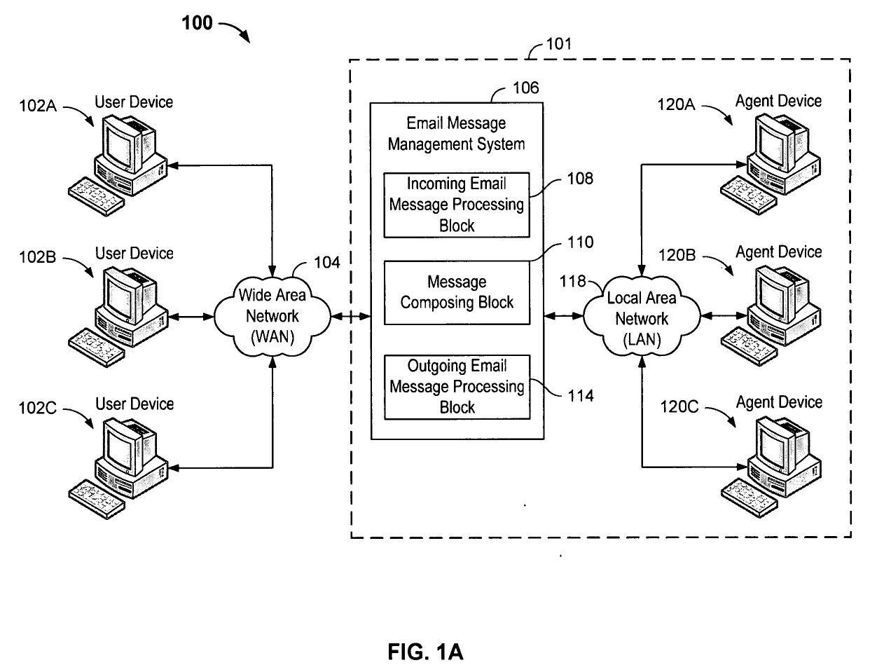

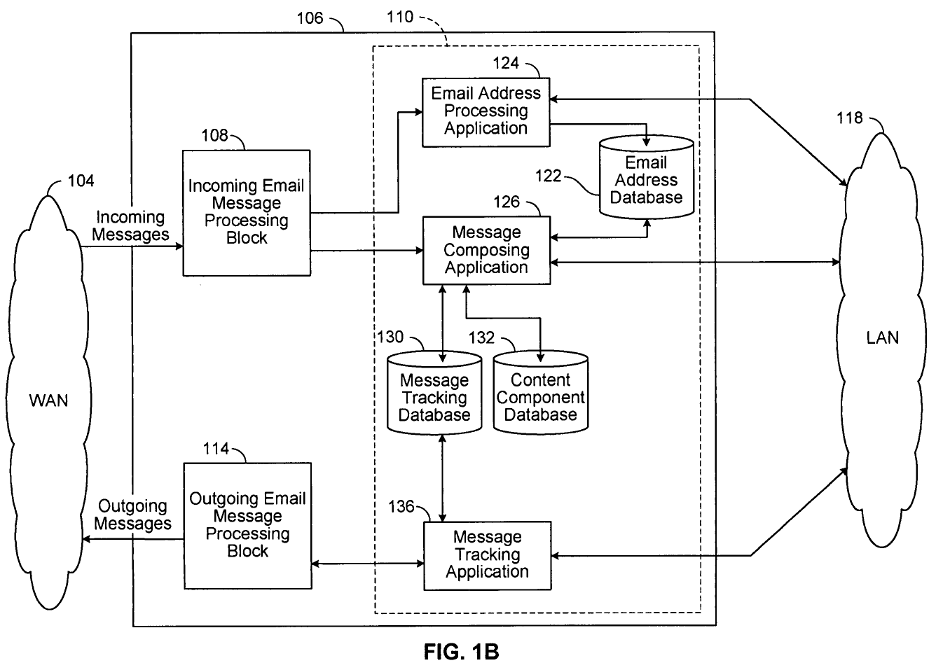

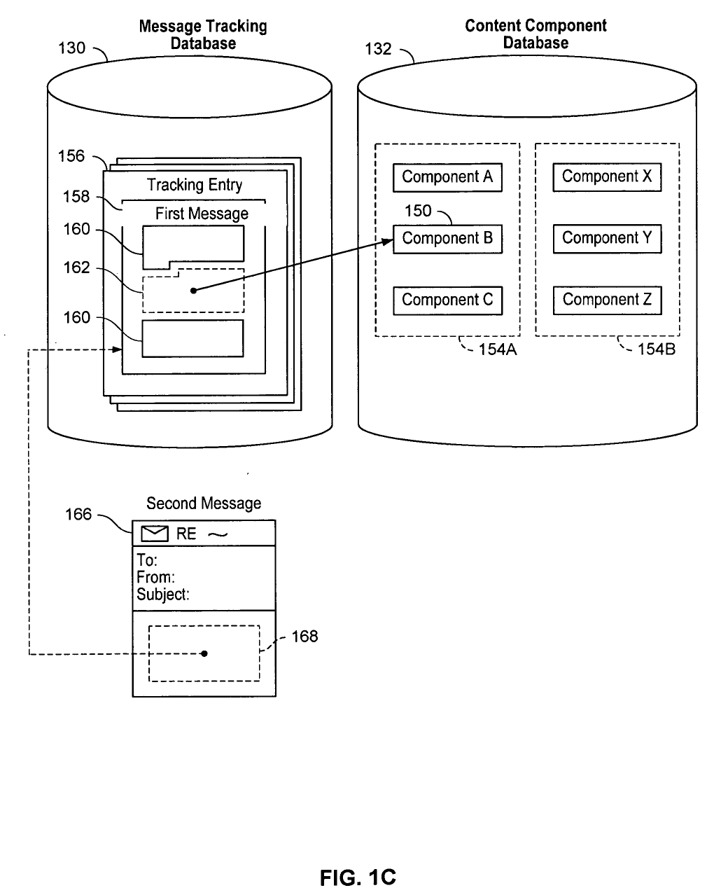

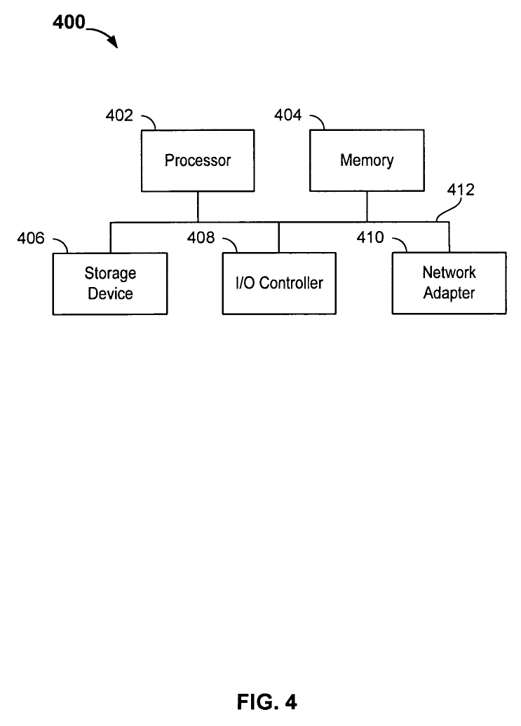

FIG. 1A is a block diagram of an exemplary environment 100 in which a method of tracking email messages may be applied. A company may use an ERMS 106 to process email messages to and from a plurality of customers (“users”). For example, the boundary 101 may represent the company's computer network (the company 101) within which email messages may be processed and tracked. The ERMS 106 may be capable of receiving user email messages, processing them, responding to them, and tracking the responses. In some implementations, the ERMS 106 runs on a computer device of the type shown in FIG. 4.

As shown, the ERMS 106 is coupled to a wide-area network (WAN) 104, such as the Internet or a wireless network, in some implementations. User devices 102A, 102B and 102C connect to the WAN 104. Users may use the user devices 102A, 102B or 102C to interact with the company 101 through its ERMS 106. Within the company's network 101, the ERMS 106 connects to a local area network (LAN) 118. The LAN 118 may be, for example, an Ethernet network. Agent devices 120A, 120B and 120C connect to the LAN 118. Agents may use the agent devices 120A, 120B or 120C to interact with the ERMS 106. For example, agents using agent devices 120A, 120B or 120C may provide content for responses to messages received from users by the ERMS 106. In this manner, agents may direct and participate in the email message processing and response processing performed by the ERMS 106.

In some implementations, the ERMS 106 may be used to send a reply message to an email message. The email message may have been sent from a user email address, by a user operating user device 102A, 102B or 102C. The ERMS 106 may track the reply message by using an email tracking address. For example, when replying to an email message sent by a user, the ERMS 106 may identify an email tracking address and set a sent-from field (a “from” field) and a recipient-on-reply field (a “repy-to” field) to the email tracking address in the reply message. The email tracking address may include a unique tracking number, for example case12345@xyzcompany.com. When received at the user email address, the reply message may appear as having been sent from the email tracking address. If the user replies to the reply message, the user reply message may be sent to the email tracking address.

In other implementations, the ERMS 106 may send a plurality of email messages to a plurality of user email addresses. For example, an ERMS 106 maintained by a clothier may periodically send email messages to user email addresses announcing upcoming sales. An agent using agent device 120A, 120B or 120C may create the email messages, which may invite replies. For example, to assess the effectiveness of email-based marketing campaigns, the clothier may solicit responses in exchange for additional discounts or rebates. To track email messages that are associated with the marketing campaign, the ERMS 106 may identify an email tracking address and may set the sent-from or recipient-on-reply fields of each email message to the email tracking address. The email tracking address could be an alias or a generic name. For example, one marketing campaign of a clothier may use a generic name, like SpringSale@xyzclothier.com, as an email tracking address. Another marketing campaign may simply display an alias in the sent-from field, like “XYZ Clothier Spring Sale.” Properties associated with the alias may include the full email tracking address, SpringSale@xyzclothier.com. If a user replies to one of the email messages, the reply may be directed to the email tracking address. For example, if a user replied to an email message to obtain an additional discount or rebate, the reply may be automatically directed to SpringSale@xyzclothier.com. The email tracking address may be a virtual email address. For example, the email tracking address may not be associated with one particular email client inbox, but it may nevertheless be configured to resolve to the ERMS 106 in a manner that facilitates tracking and further processing.

To process email messages, the ERMS 106 may comprise one or more processing blocks. As shown in the exemplary environment 100, the ERMS 106 includes an incoming email message processing block 108, a message composing block 110, and an outgoing email message processing block 114.

In the exemplary environment 100, the incoming email message processing block 108 may receive an incoming email message from a user email address. The email message may have been composed and sent by a user employing the user device 102A, 102B or 102C. The incoming email message processing block 108 may include an incoming email message server (not shown), for example, a Post Office protocol 3 (POP3) server. The incoming email message processing block 108 may also include a content extraction application (not shown) to process an incoming email message to determine its subject matter (“content”). The content extraction application may apply keyword analysis, natural language processing, or other content extraction methods to determine subject matter.

With the message composing block 110, the ERMS 106 may provide content for outgoing email messages. In some implementations, the content may be responsive to incoming email messages from users. For example, a user may send an email message to the company 101 to inquire about one of the company's products. The ERMS 106 may provide content that is responsive to the user email message inquiry. To provide content, the ERMS 106 may receive input from a human agent using one of the agent devices 120A, 120B or 120C that specifies a basis for the content. The ERMS 106 may also automatically provide content that is responsive to the user email message inquiry. For example, based on subject matter extracted by the incoming email message processing block, the ERMS 106 may search a content component database (described with reference to FIG. 1B) and retrieve from the content component database content that is responsive to the user email message inquiry. The ERMS 106 may, in an automated manner, search the content component database for content that is responsive the user email message inquiry. In other implementations, instead of being responsive to particular user email message inquiries, the content may be advertising or marketing content developed and provided by agents using agent devices 120A, 120B or 120C.

In addition to providing content for outgoing email messages, an exemplary message composing block 110 may identify a user email address to which the outgoing email message is sent, and may generate an email tracking address. In the case of a reply to an email message inquiry received from a user, the user email address may be the sender's address. Or, in the case of a marketing campaign, the ERMS 106 may retrieve a user email address from an email address database (shown in FIG. 1B). For example, the ERMS 106 may retrieve from the database a user email address that corresponds to a company's customer in order to send a message to that customer announcing a special offer or an upcoming sale. The ERMS 106 may generate an email tracking address in order to track the outgoing email message. The email tracking address may comprise a case number, for example, case12345@xyzcompany.com, which the ERMS 106 can use to track the chain of email messages. The email tracking address may also comprise a generic name, for example, SpringSale@xyclothier.com, and the email tracking address may be common to all outgoing email messages associated with the marketing campaign. For example, if the clothier sends an announcement of an upcoming sale to 50 different customers, each customer may receive an announcement that appears to have been sent from SpringSale@xyclothier.com. If a customer replies to one of the email messages, the reply may be directed to SpringSale@xyclothier.com.

Once the ERMS 106 has provided content for an outgoing email message, an outgoing email message processing block 114 prepares the outgoing email message for delivery to the user. The outgoing email message processing block may include an outgoing email message server, for example, a Simple Mail Transfer Protocol (SMTP) server.

In some implementations, the outgoing email message may comprise only a link to content that remains within the ERMS 106 until the user reads the email message. The link may include Hypertext Markup Language (HTML) content that can be used to request the response when the user reads the response message. When the user reads the response message, a request for the response may be sent to the outgoing email message processing block 116, which then may, in conjunction with the message composing block 110, deliver the response.

FIG. 1B is a block diagram showing additional details of an exemplary message processing block 110 that is shown in FIG. 11A. The exemplary message processing block 110 includes an email address database 122 and an email address processing application 124.

The email address database 122 may store user email addresses that are associated with users. The users may be users who have previously submitted email messages to the ERMS 106. For example, the ERMS 106 may receive from a user an incoming email messages via its incoming email message processing block 108. The incoming email message processing block 108 may extract the email address from the incoming email message and make this email address available to the email address processing application 124. The email address processing application 124 may then store the email address in the email address database 122. The email address processing application 124 also connects to the LAN 118, allowing agents using agent devices 120A, 120B and 120C (shown in FIG. 1A) to enter email addresses to be stored. For example, an agent of the earlier-mentioned clothier using agent device 120A may enter a set of email addresses associated with customers of the clothier. Or, the agent may input a commercially available prospect list of email addresses.

The exemplary message processing block 110 also includes a message composing application 126, a message tracking database 130 and a content component database 132. The message composing application 126 compiles content for outgoing email messages. Some of the content may be stored in the content component database 132. For example, in implementations where the ERMS 106 automatically responds to incoming user email message inquiries, responses to common inquiries may be stored in the content component database 132. In such implementations, the incoming email message processing block 108 may determine the subject matter of an incoming user email message inquiry. Based on the determined subject matter, the message composing application 126 may search the content component database 132 for content components that are responsive to the user email message inquiry. For example, a computer user might send an email message to a computer manufacturer to request assistance in configuring a new ABC Computer to perform a specific task, such as automatically powering on at a particular time. Upon receiving the email message, the incoming email message processing block 108 may apply a natural language processing algorithm to the user's email message to determine that the email message content relates to configuring a scheduled startup feature on the ABC Computer. Based on this content, the message composing application may search the content component database 132 and may retrieve content components related to configuring a scheduled startup feature on the ABC Computer. The message composing application 126 may then assemble retrieved content components into a message, add a salutation and closing and store the message, for example in the message tracking database 130.

The message composing application 126 may also generate an email tracking address to associate with the stored message. The tracking email message could include a case number, for example, case12345@xyzcompany.com. The message composing block 110 may set a sent-from field and a recipient-on-reply field in the stored email message to the email tracking address. This may cause the message appear to have originated from the email tracking address. It may also direct any replies to the message to the email tracking address. Once the ERMS 106 associates the email tracking address with a reply to a user email message, the ERMS 106 may also store the original user email message in the message tracking database 130. The ERMS 106 may also associate the email tracking address with the original email message. In this manner, the ERMS 106 can track email chains using the email tracking address.

In some implementations, the message composing application 126 may create content for an outgoing marketing email message. The message composing application 126 may retrieve content from the content component database 132, or the message composing application 126 may receive content from an agent using one of the agent devices 120A, 120B or 120C. For example, an agent using agent device 120A may create marketing campaign content. The message composing application 126 may also retrieve a set of email addresses from the email address database 122, to which outgoing marketing email messages including the content may be sent. The message composing application 126 may further generate an email tracking address, or a series of email tracking addresses, to associate with the outgoing marketing email messages. The ERMS 106 may associate an email tracking address to an outgoing marketing email message by setting sent-from and recipient-on-reply fields in the outgoing marketing email messages to the email tracking address. The outgoing marketing email messages may then be stored in the message tracking database.

The exemplary message processing block 110 also includes a message tracking application 136. The message tracking application 136 couples the message tracking database 130 to the outgoing email message processing block 114. When outgoing email messages that are stored in the message tracking database 130 are ready to be sent, the message tracking application 136 may transmit the messages to the outgoing email message processing block 114 for delivery to their recipients.

The message tracking application 136 may also sort and display messages in the message tracking database 130. For example, an agent using one of the agent devices 120A, 120B or 120C may wish to review a chain of related email messages. The chain may include an original email message from a user email address, a reply created and sent by the ERMS 106, and a reply to the reply, sent by the user. Each of these messages may be stored in the message tracking database 130, and the message tracking application 136 may locate each email message in the database and display it to the agent. Similarly, an agent may wish to review email message associated with a particular marketing campaign. An original outgoing marketing email message and subsequent reply email messages from users may be stored in the message tracking database 130. The messages may be associated with a particular email tracking address. The message tracking application 136 may search the message tracking database 130 based on that email tracking address and display the results to the agent.

FIG. 1C is a block diagram showing additional details of an exemplary message tracking database 130 and an exemplary content component database 132 that are shown in FIG. 1B. The response component database 132 may comprise a plurality of solution components or response components (“components”), of which Component B 150 and Component C are two. Each component may be a specific solution to a common problem or a specific response to a common inquiry received by the ERMS 106. For example, Component B 150 may be a solution to a common configuration problem for an ABC Computer; Component C may be a response to an inquiry regarding software updates that may be downloaded for the same product. The components may be indexed into, or organized by, related categories. For example, a category 154A may include components related to an ABC Computer; a category 154B may include components related to different marketing campaigns of the XYZ Clothier. The components in the response component database 132 may be modified and updated by agents using the agent devices 120A, 120B or 120C (shown in FIG. 1A). Or, the ERMS 106 may update the components based on email message responses created by human agents. For example, the ERMS 106 may adaptively “learn” updates to components based on responses entered by human agents.

The message tracking database 130 may include a plurality of response entries, each of which may be similar to the tracking entry 156 shown in FIG. 1C. The message 158 may comprise one or more components, or links 162A and 162B to components in the response component database 132. The message 158 may also include filler 160, which may include text that is not directly related to the subject matter of the user email message. For example, the filler 160 may include a generic salutation and closing appropriate for a response message, along with a brief summary of the subject matter of the original user email message.

To create the message 158, the message composing application 126 (shown in FIG. 1B) may search the response component database 132 for one or more components that are pertinent to the subject matter extracted from the user email message. The message composing application 126 may then incorporate the one or more pertinent components and filler 160 into a message 158.

After the message composing application 126 creates the message 158 and stores it in the message tracking database 130, the message tracking application 136 may convey it to the outgoing email message processing block 114 for delivery to the user email address. In some implementations, the actual stored message (a “first message”) 158 is sent to the user email address. In other implementations, a second message 166 comprising only a link 168 to the first message 158 is sent. Here, when the user accesses the second message 166, the link 168 causes a request to be sent to the ERMS 106 to deliver the first message 158 to the user. For example, the link 168 could include HTML content that causes the first message 158 to be dynamically delivered after the user accesses the second message 166. The link 168 could implement other methods of delivering dynamic content. As an example, the link could comprise Extensible Markup Language (XML) or Multipurpose Internet Mail Extensions (MIME), such as, but not limited to XML, Flash, and Dynamic HTML (DHTML).

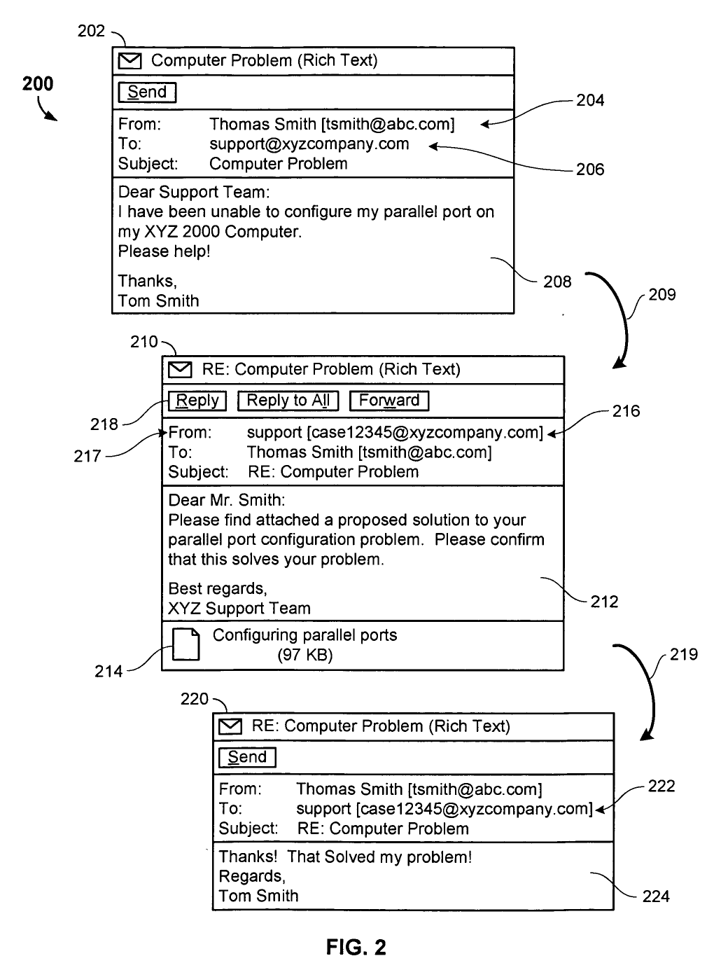

FIG. 2 is a diagram 200 of an exemplary chain of related email messages that could be tracked by the ERMS in FIG. 1A or FIG. 1B. Message 202 represents an exemplary initial email message received by the ERMS 106 from a user email address. The exemplary email message 202 includes the sender's email address 204 in a sent-from field and the recipient's email address 206. The recipient's email address 206 could be a general email address account set up to receive general email inquiries. The email message may also include content 208 from the sender.

In response (209) to the user's email message 202, the ERMS 106 may generate a reply message 210. The reply message 210 may include content 212 that is pertinent to the content of the original email message 202. The reply message 210 may also include an attachment 214. When creating the reply message 210, the ERMS 106 may generate an email tracking address 216, shown in the exemplary reply message as “support [case12345@xyzcompany.com].” The ERMS 106 may set the sent-from field 217 in the reply message to the email tracking address 216. The ERMS may also set a recipient-on-reply field (not shown) to the email tracking address 216. Thus, if the user replies (219) to the reply message 210, for example, by selecting the reply function 218, the user's reply message 220 may be automatically directed to the email tracking address 216. That is, when the user selects the reply function 218, the user's email client may automatically generate message 220, directed to the email tracking address 216. In some implementations, the recipient-on-reply field in the reply message 210 is fixed, such that the user cannot modify it.

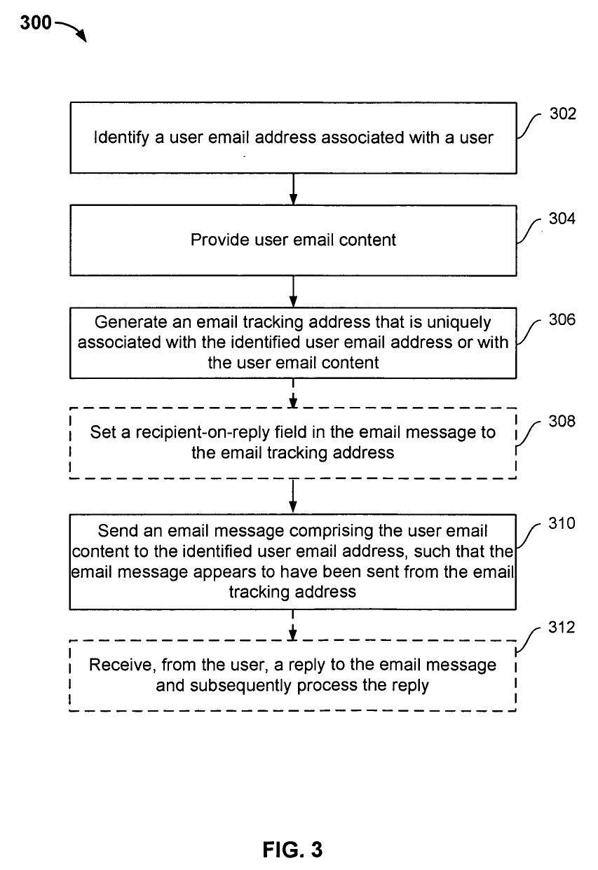

FIG. 3 is a flow diagram of a method 300 that the ERMS 106 that is shown in FIG. 1A and FIG. 1B can use to track email addresses. The method may be performed in the system 100. For example, a computer program product can include instructions that cause a processor of the ERMS 106 to perform the actions of method 200. The actions enumerated below are included in the method 300.

In an action 302, the ERMS 106 identifies a user email address associated with a user. For example, the message composing application 126 may identify an email address from the email address database 122. The identified email address may be, for example, associated with a user who previously sent a message to the ERMS 106, a previous customer of a company maintaining the ERMS 106, a prospect email address from a commercially available list, or an email address from another source.

In an action 304, the ERMS 106 provides user email content. For example, the message composing application 126 may search the content component database 132 for content 212 that is responsive to the subject matter 208 of the user email message inquiry 202. As another example, the message composing application 126 may receive content from an agent using an agent device 120A, 120B or 120C.

In an action 306, the ERMS 106 generates an email tracking address that is uniquely associated with the identified user email address or with the user email content. For example, the message composing application 126 may generate the email tracking address 216. The email tracking address 216 may be selected from email addresses that are stored in the email address database 122, or the message composing application 126 may generate the email tracking address by running a predetermined algorithm or selecting the email tracking address from a pool of possible email tracking addresses.

In an optional action 308, the ERMS 106 sets a recipient-on-reply field in the email message to the email tracking address. For example, after selecting the email tracking message, the message composing application 126 may associate the email tracking address with an outgoing email message stored in the message tracking database. Specifically, the message composing application 126 may set a recipient-on-reply field to the email tracking message before the outgoing email message is sent to the user.

In an action 310, the ERMS 106 sends an email message comprising the user email content to the identified user email address, such that the email message appears to have been sent from the email tracking address. For example, the message composing application 126 may set the sent-from field 217 in the outgoing email message 210 to the email tracking address 216. The email tracking address may direct any reply messages back to the ERMS 106.

In an optional action 312, the ERMS 106 receives, from the user email address, a reply to the email message, and the ERMS 106 subsequently processes the reply. For example, after a user receives the outgoing email message 210 at the user email address, the user may reply (219) to the email message by selecting the reply function 218. This action by the user may cause the user's email message client to create the reply message 220. Upon entering reply text, such as reply text 224, the user may send the reply message 220. Because the sent-from field is set to the email tracking address 216, the reply message 220 may be directed back to the ERMS 106. The ERMS 106 may receive the user's reply message 220 and may store it in the message tracking database 130 and associated with the outgoing message 210.

FIG. 4 is a block diagram of an exemplary computing device 400 that may be included in the user devices 102A, 102B and 102C; the agent devices 120A, 120B and 120C; the supervisor device 122; or the ERMS 106 that are shown in FIG. 1A, according to some implementations.

The computing device 400 includes a processor 402, a memory 404, a storage device 406, an input/output (I/O) controller 408, and a network adaptor 410. Each of the components 402, 404, 406, 408, and 410 are interconnected using a system bus 412.

The processor 402 is capable of processing instructions for execution in the computing device 400. In some implementations, the processor 402 is a single-threaded processor. In other implementations, the processor 402 is a multi-threaded processor. The processor 402 is capable of processing instructions stored in the memory 404 or on the storage device 406 to display graphical information for a graphical user interface (GUI) on an external input/output device that is coupled to the input/output controller 408.

The memory 404 stores information within the computing device 400. In some implementations, the memory 404 is a computer-readable medium. In some implementations, the memory 404 is a volatile memory unit. In other implementations, the memory 404 is a non-volatile memory unit.

The storage device 406 is capable of providing mass storage for the computing device 400. In some implementations, the storage device 406 is a computer-readable medium. In various different implementations, the storage device 406 may be a floppy disk device, a hard disk device, an optical disk device, or a tape device.

In some implementations, a computer program product is tangibly embodied in an information carrier. The computer program product contains instructions that, when executed, perform one or more methods, such as those described above. The information carrier is a computer-readable or machine-readable medium, such as the memory 404, the storage device 406, or a propagated signal.

The input/output controller 408 manages input/output operations for the computing device 400. In some implementations, the input/output controller 408 is coupled to an external input/output device, such as a keyboard, a pointing device, or a display unit that is capable of displaying various GUI's to a user.

The computing device 400 further includes the network adaptor 410. The computing device 400 uses the network adaptor 410 to communicate with other network devices. For example, the ERMS 106 and the user devices 102A, 102B and 102C include network adapters that allow them to communicate via WAN 104. Similarly, the agent devices 120A, 120B and 120C include network adapters that allow them to communicate with the ERMS 106 via the LAN 118.

A number of implementations have been described. Nevertheless, it will be understood that various modifications may be made without departing from the spirit and scope of the invention. Accordingly, other embodiments are within the scope of the following claims.

What is claimed is:

1. In a system that receives and sends electronic mail (email) messages to users, a computer program product tangibly embodied in an information carrier, the computer program product comprising instructions that, when executed, perform a method for tracking email messages, the method comprising:
identifying a user email address associated with a user;
providing user email content;
generating an email tracking address that is uniquely associated with the identified user email address or with the user email content;
sending an email message comprising the user email content to the identified user email address, such that the email message appears to have been sent from the email tracking address.

2. The computer program product of claim 1, wherein the email message is sent in response to a user email message received from the user email address.

3. The computer program product of claim 1, wherein the email message is sent as part of an unsolicited distribution of email messages to a plurality of user email addresses.

4. The computer program product of claim 3, wherein the user email content is associated with a marketing campaign.

5. The computer program product of claim 1, wherein providing the user email content comprises receiving input from a human agent, the input specifying a basis for the user email content.

6. The computer program product of claim 1, wherein providing the user email content comprises searching a content component database and selecting a content component therein to include in the user email content.

7. The computer program product of claim 1, wherein identifying the user email address comprises selecting the user email address from a database.

8. The computer program product of claim 1, wherein sending the email message to the user email address such that the email message appears to have been sent from the email tracking address comprises setting at least a sent-from field in the email message to the email tracking address.

9. The computer program product of claim 8, further comprising setting a recipient-on-reply field in the email message to the email tracking address.

10. The computer program product of claim 9, wherein the recipient-on-reply field is fixed and causes a reply to the email message to be delivered to the recipient-on-reply, even if the user attempts to change the recipient-on-reply field.

11. The computer program product of claim 1, further comprising receiving, from the user email address, a reply to the email message and subsequently processing the reply.

12. The computer program product of claim 1, wherein the email tracking address comprises a unique tracking number.

13. The computer program product of claim 1, wherein the email tracking address comprises an alias.

14. The computer program product of claim 1, wherein the email tracking address comprises a generic name.

15. The computer program product of claim 1, wherein the email tracking address is further associated with one or more related email messages.

16. In a system that receives and sends electronic mail (email) messages, a method of tracking email messages, the method comprising:
identifying a user email address associated with a user;
providing user email content;
generating an email tracking address that is uniquely associated with the identified user email address or with the user email content;
sending an email message comprising the user email content to the user at the identified user email address, such that the email message appears to have been sent from the email tracking address.
